(19) United States
(12) Patent Application Publication
(10) Pub. No.: US 2013/0338272 A1
(43) Pub. Date: Dec. 19, 2013

(54) FLAME-RETARDANT POLYESTERS WITH POLYACRYLONITRILES

(71) Applicant: BASF SE, Ludwigshafen (DE)

(72) Inventors: Roland Helmut Krämer, Mannheim (DE); Alexander König, Bruchsal (DE); Peter Deglmann, Mannheim (DE); Axel Ebenau, Schifferstadt (DE); Michael Roth, Lautertal (DE); Klaus Uske, Bad Durkheim (DE); Martin Klatt, Mannheim (DE)

(21) Appl. No.: 13/920,281

(22) Filed: Jun. 18, 2013

Related U.S. Application Data
(60) Provisional application No. 61/660,841, filed on Jun. 18, 2012.

(51) Int. Cl. C08K 3/02

(52) U.S. Cl. CPC C08K 3/02
USPC 524/80

(57) ABSTRACT

The invention relates to thermoplastic molding compositions comprising
A) from 10 to 97% by weight of a thermoplastic polyester,
B) from 0.1 to 60% by weight of red phosphorus,
C) from 1 to 25% by weight of a polyacrylonitrile homopolymer,
D) from 0 to 50% by weight of a fibrous or particulate filler, and
E) from 0 to 60% by weight of further additives,
   where the total of the percentages by weight of A) to E) is 100%.

The invention relates to thermoplastic molding compositions comprising

A) from 10 to 97% by weight of a thermoplastic polyester,
B) from 0.1 to 60% by weight of red phosphorus,
C) from 1 to 25% by weight of a polyacrylonitrile homopolymer,
D) from 0 to 50% by weight of a fibrous or particulate filler, and
E) from 0 to 60% by weight of further additives,
where the total of the percentages by weight of A) to E) is 100%.

The present invention further relates to the use of molding compositions of this type for producing fibers, foils, and moldings, and to the resultant moldings, fibers, and foils of any type.

It is known that addition of red phosphorus to thermoplastics, especially reinforced or filled polyesters, leads to effective flame retardancy (e.g. JP-A-2001/226570, JP-A-2000/328065). However, when red phosphorus is exposed to disadvantageous conditions, e.g. elevated temperature, moisture, or presence of alkali or oxygen, it tends to form decomposition products, such as phosphine and acids of mono- to pentavalent phosphorus.

A stabilizing effect can be achieved by adding oxides or hydroxides of zinc, of magnesium, or of copper. In DE-A-2625691, in addition to said stabilization by metal oxides, the phosphorus particles become complicated, and the stabilizing effect of the system is moreover not always satisfactory.

JP-A-2005/126633 discloses polyolefins which comprise polyacrylonitrile in combination with red phosphorus and metal hydroxide.

Properties requiring improvement in the known molding compositions are smoke density and heat release rate. It is also desirable to increase the amount of residue after combustion, because the resultant carbon layer retards development of a fire and thus reduces total heat release and also total smoke generation.

It was therefore an object of the present invention to develop thermoplastic polyester molding compositions which comprise red phosphorus as flame retardant and exhibit reduced smoke density and heat release rate, and an increased amount of residue after combustion.

The molding compositions of the invention comprise, as component (A), from 10 to 97% by weight, preferably from 20 to 95% by weight, and in particular from 20 to 80% by weight, of at least one thermoplastic polyester.

Polyesters A) generally used are those based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety.

Polyalkylene terephthalates of this type are known per se and are described in the literature. Their main chain comprises an aromatic ring which derives from the aromatic dicarboxylic acid. There may also be substitution in the aromatic ring, e.g. by halogen, such as chlorine or bromine, or by C₁-C₄-alkyl groups, such as methyl, ethyl, iso- or n-propyl, or n-, iso- or tert-butyl groups.

These polyalkylene terephthalates may be produced by reacting aromatic dicarboxylic acids, or their esters or other ester-forming derivatives, with aliphatic dihydroxy compounds in a manner known per se.

Preferred dicarboxylic acids are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Particularly preferred polyesters (A) are polyalkylene terephthalates derived from alkanediols having from 2 to 6 carbon atoms. Among these, particular preference is given to polyethylene terephthalate, polypropylene terephthalate and polybutylene terephthalate, and mixtures of these. Preference is further given to PET and/or PBT where these comprise up to 1% by weight, preferably up to 0.75% by weight, of 1,6-hexanediol and/or 2-methyl-1,5-pentanediol as further monomer units.

The intrinsic viscosity of the polyesters (A) is generally in the range from 50 to 220, preferably from 80 to 160 (measured in 0.5% strength by weight solution in a phenol/o-dichlorobenzene mixture (in a weight ratio of 1:1) at 25° C.) in accordance with ISO 1628.

Particular preference is given to polyesters whose carboxy end group content is up to 100 meq/kg of polyester, preferably up to 50 meq/kg of polyester and in particular up to 40 meq/kg of polyester. Polyesters of this type may be produced, for example, by the process of DE-A 44 01 055. The carboxy end group content is usually determined by titration methods (e.g. potentiometry).

In particular, preferred molding compositions comprise, as component A), a mixture of polyesters other than PBT, for example polyethylene terephthalate (PET). The proportion of the polyethylene terephthalate, for example, in the mixture is preferably up to 50% by weight, in particular from 10 to 35% by weight, based on 100% by weight of component A).

It is also advantageous to use PET recyclates (also termed scrap PET), optionally mixed with polyalkylene terephthalates, such as PBT.

Recyclates are generally either
1) those known as post-industrial recyclates: these are production wastes during polycondensation or during processing, e.g. sprues from injection molding, start-up material from injection molding or extrusion, or edge trims from extruded sheets or foils, or
2) post-consumer recyclates: these are plastic items which are collected and treated after utilization by the end consumer. Blow-molded PET bottles for mineral water, soft drinks and juices are easily the predominant items in terms of quantity.

Both types of recyclate may be used either as ground material or in the form of pellets. In the latter case, the crude recyclates are separated and purified and then melted and pelletized using an extruder. This usually facilitates handling and free flow, and metering for further steps in processing.

The recyclates used may be either pelletized or in the form of regrind. The edge length should not be more than 10 mm, preferably less than 8 mm.

Because polyesters undergo hydrolytic cleavage during processing (due to traces of moisture) it is advisable to predry the recyclate. The residual moisture content after drying is preferably <0.2%, in particular <0.05%.

Another group to be mentioned is that of fully aromatic polyesters derived from aromatic dicarboxylic acids and aromatic dihydroxy compounds.

Suitable aromatic dicarboxylic acids are the compounds previously mentioned for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the general formula

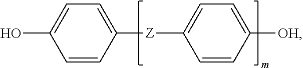

where Z is an alkylene or cycloalkylene group having up to 8 carbon atoms, an arylene group having up to 12 carbon atoms, a carbonyl group, a sulfonyl group, an oxygen or sulfur atom, or a chemical bond, and m is from 0 to 2. The phenylene groups of the compounds may also have substitution by C₁-C₆-alkyl or -alkoxy groups and fluorine, chlorine or bromine.

Examples of parent compounds for these compounds are dihydroxybiphenyl,
di(hydroxyphenyl)alkane,
di(hydroxyphenyl)cycloalkane,
di(hydroxyphenyl)sulfide,
di(hydroxyphenyl)ether,
di(hydroxyphenyl) ketone,
di(hydroxyphenyl) sulfoxide,
α,α′-di(hydroxyphenyl)dialkylbenzene,
di(hydroxyphenyl) sulfone, di(hydroxybenzoyl)benzene,
   resorcinol, and hydroquinone, and also the ring-alkylated and ring-halogenated derivatives of these.

Among these, preference is given to
4,4′-dihydroxybiphenyl,
2,4-di(4′-hydroxyphenyl)-2-methylbutane,
α,α′-di(4-hydroxyphenyl)-p-diisopropylbenzene,
2,2-di(3′-methyl-4′-hydroxyphenyl)propane, and
2,2-di(3′-chloro-4′-hydroxyphenyl)propane,
   and in particular to
2,2-di(4′-hydroxyphenyl)propane,
2,2-di(3′,5-dichlorodihydroxyphenyl)propane,
1,1-di(4′-hydroxyphenyl)cyclohexane,
3,4′-dihydroxybenzophenone,
4,4′-dihydroxydiphenyl sulfone and
2,2-di(3′,5′-dimethyl-4′-hydroxyphenyl)propane
   and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in U.S. Pat. No. 3,651,014. Corresponding products are also available commercially, e.g. Hytrel® (DuPont).

According to the invention, the term polyesters also includes halogen-free polycarbonates. Examples of suitable halogen-free polycarbonates are those based on diphenols of the general formula

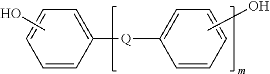

where Q is a single bond, a C₁-C₈-alkylene, C₂-C₃-alkylidene, C₃-C₆-cycloalkylidene, C₆-C₁₂-arylene group, or —O—, —S— or —SO₂—, and m is an integer from 0 to 2.

The phenylene radicals of the diphenols may also have substituents, such as C₁-C₆-alkyl or C₁-C₆-alkoxy.

Examples of preferred diphenols of the formula are hydroquinone, resorcinol, 4,4′-dihydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as component A), and preference is given to the copolycarbonates of bisphenol A, as well as to the bisphenol A homopolymer.

Suitable polycarbonates may be branched in a known manner, and indeed preferably by incorporating from 0.05 to 2.0 mol %, based on the total of the diphenols used, of at least trifunctional compounds, for example those having three or more than three phenolic OH groups.

Polycarbonates which have proven particularly suitable have relative viscosities ηᵣₑₗ of from 1.10 to 1.50, in particular from 1.25 to 1.40. This corresponds to an average molar mass M_{w} (weight-average) of from 10 000 to 200 000 g/mol, preferably from 20 000 to 80 000 g/mol.

The diphenols of the general formula are known per se or may be produced by known methods.

The polycarbonates may, for example, be produced by reacting the diphenols with phosgene in the interfacial process, or with phosgene in the homogeneous-phase process (known as the pyridine process), and in each case the desired molecular weight may be achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkyl-phenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates composed of halogen-free diphenols, of halogen-free chain terminators and, if used, halogen-free branching agents, where the content of subordinate amounts at the ppm level of hydrolyzable chlorine, resulting, for example, from the preparation of the polycarbonates with phosgene in the interfacial process, is not regarded as meriting the term halogen-comprising for the purposes of the invention. Polycarbonates of this type with contents of hydrolyzable chlorine at the ppm level are halogen-free polycarbonates for the purposes of the present invention.

Other suitable components A) which may be mentioned are amorphous polyester carbonates, where during the preparation process phosgene has been replaced by aromatic dicarboxylic acid units, such as isophthalic acid and/or terephthalic acid units. Reference may be made at this point to EP-A 711 810 for further details.

EP-A 365 916 describes other suitable copolycarbonates having cycloalkyl radicals as monomer units.

It is also possible for bisphenol A to be replaced by bisphenol TMC. Polycarbonates of this type are obtainable from Bayer with the trademark APEC HT®.

Flame retardant B) according to the invention is elemental red phosphorus, which is in particular combined with glassfiber-reinforced molding compositions and which can be used in untreated form.

However, particularly suitable materials are preparations in which the phosphorus has been surface-coated with low-molecular-weight liquid substances, for example with silicone oil, with paraffin oil, or with esters of phthalic acid (in particular dioctyl phthalate, see EP 176 836), or with adipic acid, or with polymeric or oligomeric compounds, e.g. with phenolic resins or aminoplastics, or else with polyurethanes (see EP-A 384 232, DE-A 196 48 503). Amounts comprised of these “phlegmatizing agents” are generally from 0.05 to 5% by weight, based on 100% by weight of B).

Other materials that are suitable as flame retardants are concentrates of red phosphorus, e.g. in a polyamide or elastomer. Particularly suitable concentrate polymers are polyolefin homo- and copolymers. However, the proportion of the concentrate polymer should not amount to more than 35% by weight, based on the weight of components A) and B) in the molding compositions of the invention.

Preferred concentrate compositions are
B₁) from 30 to 90% by weight, preferably from 45 to 70% by weight, of a polyamide or elastomer,
B₂) from 10 to 70% by weight, preferably from 30 to 55% by weight, of red phosphorus.

The polyamide used for the masterbatch is preferably PA6 and/or PA66, in order that no adverse effect on the molding composition arises from incompatibility phenomena or from melting point differences.

The average size (d₅₀) of the phosphorus particles dispersed in the molding compositions is preferably in the range from 0.0001 to 0.5 mm; in particular from 0.001 to 0.2 mm.

The content of component B) in the molding compositions of the invention is from 0.1 to 60% by weight, preferably from 0.5 to 40% by weight, and in particular from 1 to 15% by weight, based on the entirety of components A) to E).

The molding compositions of the invention comprise, as component C), from 1 to 25% by weight, preferably from 1 to 15% by weight, and in particular from 1 to 11% by weight, of a polyacrylonitrile homopolymer. This is the term for polymers of the structure

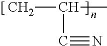

Polymers of this type can be produced by free-radical polymerization of acrylonitrile, and the usual industrial polymerization process here generally takes place in water, with initiators.

The average molecular weight M_{w} of preferred polyacrylonitriles is from 10 000 to 400 000, in particular from 50 000 to 350 000, in accordance with DIN 55672-2:2008-06 by means of GPC, part 2, PMMA as eluent (standard).

Particular preference is given to polyacrylonitriles that are mixed in the form of powder, pellets, chips, or tablets with the other components A) and B), and also optionally D) and E), and compounded.

Fibrous or particulate fillers D) (differing from E)) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar, and amounts that can be used of these are from 1 to 50% by weight, in particular from 5 to 45% by weight, preferably from 10 to 40% by weight.

Preferred fibrous fillers which may be mentioned are carbon fibers, aramid fibers and potassium titanate fibers, and particular preference is given to glass fibers in the form of E glass. These may be used as rovings or in the commercially available forms of chopped glass.

The fibrous fillers may have been surface-pretreated with a silane compound to improve compatibility with the thermoplastics.

Suitable silane compounds have the general formula:

(X—(CH₂)ₙ)ₖ—Si—(O—CₘH₂ₘ₊₁)₄₋ₖ

where the definition of the substituents is as follows:

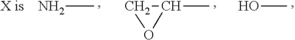

n is an integer from 2 to 10, preferably 3 to 4,
m is an integer from 1 to 5, preferably 1 to 2, and
k is an integer from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts generally used of the silane compounds for surface coating are from 0.01 to 2% by weight, preferably from 0.025 to 1.0% by weight, and in particular from 0.05 to 0.5% by weight (based on D)).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Other fillers which may be mentioned are kaolin, calcined kaolin, wollastonite, talc and chalk, and also, additionally, lamellar or acicular nanofillers, preferably in amounts of from 0.1 to 10%. Preferred materials used for this purpose are boehmite, bentonite, montmorillonite, vermiculite, hectorite, and laponite. In order to obtain good compatibility of the lamellar nanofillers with the organic binder, the lamellar nanofillers are organically modified in accordance with the prior art. The addition of the lamellar or acicular nanofillers to the nanocomposites of the invention leads to a further increase in mechanical strength.

The molding compositions of the invention can comprise, as component E), from 0 to 60% by weight, in particular up to 50% by weight, in particular up to 30% by weight, of further additives and processing aids.

The molding compositions of the invention can comprise, as component E), from 0 to 5% by weight, preferably from 0.05 to 3% by weight and in particular from 0.1 to 2% by weight of at least one ester or amide of saturated or unsaturated aliphatic carboxylic acids having from 10 to 40 carbon atoms, preferably from 16 to 22 carbon atoms with saturated aliphatic alcohols or amines having from 2 to 40 carbon atoms, preferably from 2 to 6 carbon atoms.

The carboxylic acids can be mono- or dicarboxylic acids. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be 1- to 4-hydric. Suitable alcohols are n-butanol, n-octanol, stearyl alcohol, ethylene glycol, propylene glycol, neopentyl glycol, pentaerythritol, preferably ethylene glycol, glycerol and pentaerythritol.

The aliphatic amines can be 1- to 3-valent. Examples of these are stearylamine, ethylenediamine, propylenediamine, hexamethylenediamine, di(6-aminohexyl)amine, particularly preferably ethylenediamine and hexamethylenediamine. Esters or amides preferred are accordingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or of various amides, or of esters and amides in combination, in any desired mixing ratio.

Other conventional additives E) are by way of example amounts of up to 40% by weight, preferably up to 30% by weight, of elastomeric polymers (often also termed impact modifiers, elastomers, or rubbers).

These are very generally copolymers preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these which may be mentioned here are acrylic acid, methacrylic acid and derivatives thereof, e.g. glycidyl(meth)acrylate, and also maleic anhydride.

Copolymers of ethylene with acrylic acid and/or methacrylic acid and/or with the esters of these acids are another group of preferred rubbers. The rubbers may also, additionally, comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formula I, II, III or IV

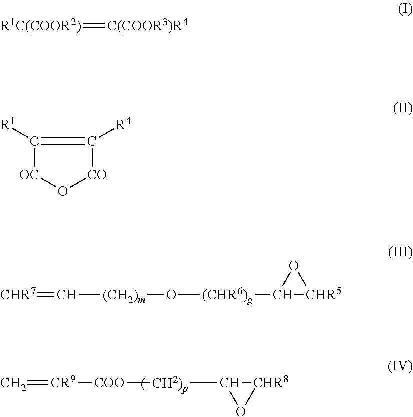

where R¹ to R⁹ are hydrogen or alkyl groups having from 1 to 6 carbon atoms, and m is an integer from 0 to 20, g is an integer from 0 to 10 and p is an integer from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising acid anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 10 to 40% by weight, of n-butyl acrylate and/or 2-ethylhexyl acrylate.

Other preferred (meth)acrylates are the methyl, ethyl, propyl, isobutyl and tert-butyl esters.

Other materials that can also be used alongside these are vinyl esters and vinyl ethers as comonomers.

The ethylene copolymers described above may be produced by processes known per se, preferably by random copolymerization at high pressure and elevated temperature. Appropriate processes are well known.

Other preferred elastomers are emulsion polymers whose preparation is described, for example, by Blackley in the monograph “Emulsion polymerization”. The emulsifiers and catalysts which can be used are known per se.

In principle it is possible to use homogeneously structured elastomers or else those with a shell structure. The shell-type structure is determined by the sequence of addition of the individual monomers; the morphology of the polymers is also affected by this sequence of addition.

Monomers which may be mentioned here, merely in a representative capacity, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have two or more shells composed of a rubber phase.

If one or more hard components (with glass transition temperatures above 20° C.) are involved, besides the rubber phase, in the structure of the elastomer, these are generally produced by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use here relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

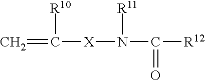

where the definition of the substituents may be as follows:
R¹⁰ is hydrogen or C₁-C₄-alkyl,
R¹¹ is hydrogen or C₁-C₈-alkyl or aryl, in particular phenyl,
R¹² is hydrogen, C₁-C₁₀-alkyl, C₆-C₁₂-aryl or —OR¹³
R¹³ is C₁-C₈-alkyl or C₆-C₁₂-aryl, which may optionally be substituted by O- or N-containing groups,
X is a chemical bond, C₁-C₁₀-alkylene or C₆-C₁₂-arylene, or

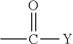

### Y is O—Z or NH—Z, and

Z is C₁-C₁₀-alkylene or C₆-C₁₂-arylene.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethyl-amino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of double-bond unsaturation in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n-butyl | styrene, acrylonitrile, methyl |
| | acrylate, ethylhexyl acrylate, | methacrylate |
| | or a mixture of these | |
| II | as I, but with concomitant use of | as I |
| | crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, methyl | first envelope composed of |
| | methacrylate, or a mixture of | monomers as described under I |
| | these | and II for the core, second |
| | | envelope as described under I or |
| | | IV for the envelope |

These graft polymers, in particular ABS polymers and/or ASA polymers, are preferably used in amounts of up to 40% by weight for the impact-modification of PBT, optionally in a mixture with up to 40% by weight of polyethylene terephthalate. Blend products of this type are obtainable with the trademark Ultradur®S (previously Ultrablend®S from BASF AG).

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be produced by concomitant use of crosslinking monomers or of monomers having reactive groups.

Examples of preferred emulsion polymers are n-butyl acrylate/(meth)acrylic acid copolymers, n-butyl acrylate/glycidyl acrylate copolymers or n-butyl acrylate/glycidyl methacrylate copolymers, graft polymers having an inner core made of n-butyl acrylate or based on butadiene and having an outer envelope made of the abovementioned copolymers, and copolymers of ethylene with comonomers which provide reactive groups.

The elastomers described can also be produced by other conventional processes, e.g. by suspension polymerization.

Preference is equally given to silicone rubbers, as described in DE-A 37 25 576, EP-A 235 690, DE-A 38 00 603, and EP-A 319 290.

It is also possible, of course, to use mixtures of the rubber types listed above.

The thermoplastic molding compositions of the invention can comprise, as component E), conventional processing aids, such as stabilizers, oxidation retarders, agents to counteract decomposition by heat and decomposition by ultraviolet light, lubricants and mold-release agents, colorants, such as dyes and pigments, nucleating agents, plasticizers, etc.

Examples which may be mentioned of oxidation retarders and heat stabilizers are sterically hindered phenols and/or phosphites, hydroquinones, aromatic secondary amines, such as diphenylamines, various substituted members of these groups, and mixtures of these in concentrations of up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Colorants which may be added are inorganic pigments, such as titanium dioxide, ultramarine blue, iron oxide, and carbon black, and also organic pigments, such as phthalocyanines, quinacridones and perylenes, and also dyes, such as nigrosine and anthraquinones.

Nucleating agents which may be used are sodium phenylphosphinate, alumina, silica, and preferably talc powder.

Other lubricants and mold-release agents are usually used in amounts of up to 1% by weight. Preference is given to long-chain fatty acids (e.g. stearic acid or behenic acid), salts of these (e.g. calcium stearate or zinc stearate) or montan waxes (mixtures of straight-chain saturated carboxylic acids having chain lengths of from 28 to 32 carbon atoms), or calcium montanate or sodium montanate, or low-molecular-weight polyethylene waxes or low-molecular-weight polypropylene waxes.

Examples of plasticizers which may be mentioned are dioctyl phthalates, dibenzyl phthalates, butyl benzyl phthalates, hydrocarbon oils and N-(n-butyl)benzenesulfonamide.

The inventive molding compositions may also comprise from 0 to 2% by weight of fluorine-containing ethylene polymers. These are polymers of ethylene with a fluorine content of from 55 to 76% by weight, preferably from 70 to 76% by weight.

Examples of these are polytetrafluoroethylene (PTFE), tetrafluoroethylene-hexafluoropropylene copolymers and tetrafluoroethylene copolymers with relatively small proportions (generally up to 50% by weight) of copolymerizable ethylenically unsaturated monomers. These are described, for example, by Schildknecht in “Vinyl and Related Polymers”, Wiley-Verlag, 1952, pages 484-494 and by Wall in “Fluoropolymers” (Wiley Interscience, 1972).

These fluorine-containing ethylene polymers have homogeneous distribution in the molding compositions and preferably have a particle size d₅₀ (numeric average) in the range from 0.05 to 10 μm, in particular from 0.1 to 5 μm. These small particle sizes can particularly preferably be achieved by the use of aqueous dispersions of fluorine-containing ethylene polymers and the incorporation of these into a polyester melt.

The inventive thermoplastic molding compositions may be produced by methods known per se, by mixing the starting components in conventional mixing apparatus, such as screw extruders, Brabender mixers or Banbury mixers, and then extruding them. The extrudate may be cooled and comminuted. It is also possible to premix individual components and then to add the remaining starting materials individually and/or likewise in a mixture. The mixing temperatures are generally from 230 to 290° C.

In another preferred method of operation, components B) and C), and also optionally D) and E) can be mixed with a prepolymer, compounded, and pelletized. The resultant pellets are then solid-phase-condensed, continuously or batchwise, under an inert gas, at a temperature below the melting point of component A) until the desired viscosity has been reached.

The polyester molding compositions of the invention feature excellent flame retardancy and relatively low smoke density and heat release rate. There is an increased amount of residue after combustion.

The moldings or semifinished products to be produced from the thermoplastic molding compositions in the invention can by way of example be used in the motor-vehicle industry, electrical industry, electronics industry, telecommunications industry, information technology industry, consumer electronics industry, or computer industry, or in vehicles and other means of conveyance, in ships, in spacecraft, in the domestic sector, in office equipment, in sports, in medicine, and also generally in articles and buildings components which require increased flame retardancy.

Some examples are the following: plug connectors, plugs, plug parts, cable harness components, circuit mounts, circuit mount components, three-dimensionally injection-molded circuit mounts, electrical connection elements, and mechatronic components.

### EXAMPLES

The following components were used:

Component A: Polybutylene terephthalate with intrinsic viscosity IV of 107 ml/g, determined in 0.5% by weight solution in phenol/o-dichlorobenzene (1:1) at 25° C. in accordance with DIN 53728/ISO (Ultradur® B2550 from BASF SE was used).

Component B): 50% masterbatch of red phosphorus in PBT.

Component C1): polyacrylonitrile homopolymer
M_{w}: 313 400 g/mol in accordance with DIN 55672-2:2008-06 by means of GPC, part 2, PMMA standard

Component C2): polyacrylonitrile homopolymer
M_{w}: 156 000 g/mol in accordance with DIN 55672-2:2008-06 by means of GPC, part 2, PMMA standard

Component C3): polyacrylonitrile copolymer (for comparison)
poly(vinylidene chloride-co-acrylonitrile), 80/20, CAS: 9010-76-8

Component C4): styrene-acrylonitrile copolymer (for comparison)
random copolymer of 24% of acrylonitrile and 76% of styrene

Component D1: standard chopped glass fiber for polyester with average thickness 10 μm

Component E): Pentaerythritol tetrastearate

### Production of Molding Compositions and Moldings

Compounding was used to manufacture appropriate plastics molding compositions. For this, the individual components were mixed in a ZSK 26 twin-screw extruder at throughput 20 kg/h with flat temperature profile at about 270° C., discharged in the form of strand, cooled until pelletizable, and pelletized. The test specimens for the tests listed in the tables were injection molded in an Arburg 420° C. injection molding machine at a melt temperature of about 260° C. and at a mold temperature of about 80° C.

Mechanical properties were determined in accordance with ISO 527-2/1A/5, and (unnotched)

Charpy impact resistance was determined in accordance with ISO 179-2/1eU.

Fire protection properties were measured in accordance with UL 94 on 0.8 mm specimens.

Smoke density, heat release, and residue after combustion were determined in accordance with ISO 5660-1: 2002.

The tables show the compositions of the molding compositions and the results of the measurements.

TABLE 1

| Compo- | | | | | | | | | |
|---|---|---|---|---|---|---|---|---|---|
| sition | 1 | 2 | | | | 6* | | 8 | 9 |
| [% | comp | comp | 3 | 4 | 5 | comp | 7 | comp | comp |
| by wt.] | [%] | [%] | [%] | [%] | [%] | [%] | [%] | [%] | [%] |
| A) | 74.7 | 61.7 | 59.2 | 56.7 | 51.7 | 57.4 | 53.7 | 56.7 | 51.7 |
| B) | — | 13.0 | 13.0 | 13.0 | 13.0 | 12.0 | 13.0 | 13.0 | 13.0 |
| C1) | — | — | 2.5 | 5.0 | 10.0 | — | — | — | — |
| C2) | — | — | — | — | — | — | 8.0 | — | — |
| C3) | — | — | — | — | — | 6.0 | — | — | — |
| C4) | — | — | — | — | — | — | — | 5.0 | 10 |
| D) | 25.0 | 25.0 | 25.0 | 25.0 | 25.0 | 24.6 | 25.0 | 25.0 | 25.0 |
| E) | 0.3 | 0.3 | 0.3 | 0.3 | 0.3 | — | 0.3 | 0.3 | 0.3 |

*Material decomposes on extrusion, no product obtained

TABLES 2-4

| Mechanical | | 1 | 2 | | | | 6 | | 8 | 9 |
|---|---|---|---|---|---|---|---|---|---|---|
| properties | Standard | comp | comp | 3 | 4 | 5 | comp | 7 | comp | comp |
| Modulus of | ISO 527- | 8585 | 8880 | 9177 | 9058 | 9406 | — | — | 9156 | 9192 |
| elasticity | 2/1A/5 | | | | | | | | | |
| [MPa] | | | | | | | | | | |
| Tensile stress | ISO 527- | 140.9 | 139.2 | 137 | 131.02 | 124 | — | — | 139.34 | 139.62 |
| at break | 2/1A/5 | | | | | | | | | |
| (σ_B) [MPa] | | | | | | | | | | |
| Tensile strain | ISO 527- | 3.18 | 2.92 | 2.53 | 2.32 | 1.89 | — | — | 2.73 | 2.57 |
| at break | 2/1A/5 | | | | | | | | | |
| (ε_B) [MPa] | | | | | | | | | | |
| Unnotched | ISO 179- | 71.5 | 65.0 | 60.7 | 55.6 | 50.1 | — | — | 61.5 | 58.2 |
| Charpy 23° C. | 2/1eU | | | | | | | | | |
| [kJ/m²] | | | | | | | | | | |

| | 1 | 2 | | | | 6 | | 8 | 9 |
|---|---|---|---|---|---|---|---|---|---|
| UL 94, 0.8 mm | comp | comp | 3 | 4 | 5 | comp | 7 | comp | comp |
| Total afterflame time | >90 | >30 | 96 | 125 | 25 | — | 126 | 60 | 68 |
| Ignition of cotton | Yes | Yes | Yes | Yes | No | — | No | Yes | Yes |
| indicator | | | | | | | | | |
| UL 94 classification | V- | V- | V2 | V2 | V0 | — | V1 | V2 | V2 |

| | | 1 | 2 | | | |
|---|---|---|---|---|---|---|
| Cone calorimeter 50 kW m⁻² | Standard | comp | comp | 3 | 4 | 5 |
| Average heat release at 180 s | ISO 5660-1:2002 | 284 | 154 | 137 | 131 | 125 |
| after ignition | | | | | | |
| Mass at end of test (%) | ISO 5660-1:2002 | 25 | 29 | 30 | 34 | 43 |
| Spec. extinction area [m²/kg] | ISO 5660-1:2002 | 700 | 1522 | 1235 | 959 | 1003 |
| (smoke density) | | | | | | |

1.-7. (canceled)

8. A thermoplastic molding composition comprising
A) from 10 to 97% by weight of a thermoplastic polyester,
B) from 0.1 to 60% by weight of red phosphorus,
C) from 1 to 25% by weight of a polyacrylonitrile homopolymer,
D) from 0 to 50% by weight of a fibrous or particulate filler, and
E) from 0 to 60% by weight of further additives,
where the total of the percentages by weight of A) to E) does not exceed 100%.

9. The thermoplastic molding composition according to claim 8, comprising
A) from 10 to 97% by weight of the thermoplastic polyester,
B) from 0.5 to 40% by weight of the red phosphorus,
C) from 1 to 15% by weight of the polyacrylonitrile homopolymer,
D) from 1 to 50% by weight of the fibrous or particulate filler, and
E) from 0 to 50% by weight of the further additives.

10. The thermoplastic molding composition according to claim 8, comprising
A) from 20 to 95% by weight of the thermoplastic polyester,
B) from 0.5 to 40% by weight of the red phosphorus,
C) from 1 to 15% by weight of the polyacrylonitrile homopolymer,
D) from 5 to 45% by weight of the fibrous or particulate filler, and
E) from 0 to 30% by weight of the further additives.

11. The thermoplastic molding composition according to claim 8 wherein component C) has an average molecular weight Mw of from 10 000 to 400 000 in accordance with DIN 55672-2: 2008-06, 2nd part (GPC standard PMMA).

12. The thermoplastic molding composition according to claim 8, wherein component C) is mixed in the form of pellets, powder, chips, or tablets with the other components A) and B), and also optionally D) and E), and is compounded.

13. A method for producing fibers, foils, and moldings comprising utilizing the thermoplastic molding composition according to claim 8.

14. A fiber, foil, or molding obtainable from the thermoplastic molding composition according to claim 8.
